(19) United States
(12) Patent Application Publication
(10) Pub. No.: US 2005/0056517 A1
(43) Pub. Date: Mar. 17, 2005

(54) Assembly for a motor vehicle clutch-release system

(76) Inventors: Jerome Pionnier, Lyon (FR); Sebastien Broise, Langres (FR); Christophe Poinsel, Langres (FR); Bruno Agnus, Chaumont (FR); Marcel Boisset, Chanoy (FR)

Correspondence Address: SCHWEITZER CORNMAN GROSS & BONDELL LLP, 292 MADISON AVENUE - 19th FLOOR, NEW YORK, NY, 10017, US

(21) Appl. No.: 10/937,743

(22) Filed: Sep. 9, 2004

(30) Foreign Application Priority Data
Sep. 11, 2003 (FR) 03 10696

(51) Int. Cl. F16D 23/12

(52) U.S. Cl. 192/99 S

(57) ABSTRACT

The invention provides an assembly for putting into place on the fork of a motor vehicle clutch-release system, said assembly comprising: a shoe forming a sliding surface for an endpiece of a ball pin of the clutch-release system; and a support including a housing for receiving the endpiece of the ball pin; wherein the support includes retaining means for enabling the shoe to be fastened to the support.

The present invention relates to an assembly for installing on the fork of a motor vehicle clutch-release system, and to such a system, in particular for a manual gearbox.

### BACKGROUND OF THE INVENTION

In known manner, and as shown in FIGS. 1 and 2, a motor vehicle clutch-release system comprises a clutch-release fork 1, a ball pin 2 carrying an endpiece 3 having a surface in the form of a spherical segment, and a support 4 forming a housing in which the endpiece 3 is engaged so as to define a ball-and-socket type connection 8 between the fork 1 and the ball pin 2.

The endpiece 3 bears against a shoe 5 in the form of a spherical cap placed in a setback 6 in the fork 1, the shoe 5 forming a sliding surface for the endpiece 3.

That clutch-release system operates as follows.

When a user of the motor vehicle presses the clutch pedal, the clutch-release fork 1 tilts about the ball-and-socket connection 8, either under drive from a cable connected to the clutch pedal, or via a hydraulic mechanism such as an actuator driven by a directional control valve associated with the clutch pedal. The tilting causes the tips 9 of the clutch-release fork 1 to move, thereby enabling the disks of the clutch to be decoupled.

The fork 1 may be made of steel, for example stamped sheet metal or forged steel.

The ball pin 2 which is fixed to the casing of the gearbox, e.g. by screw fastening, may be made of steel.

The shoe 5 may be made of a flexible material such as a material containing polytetrafluoroethylene (PTFE) and a metal grid, or it may be rigid such as a material containing PTFE and a metal plate.

In known clutch-release systems, the shoe 5 is not secured to the fork 1, nor is it secured to the support 4.

In some cases, the shoe 5 is stuck on the endpiece 3.

The various parts constituting the clutch-release system are generally delivered without being assembled together.

### OBJECTS AND SUMMARY OF THE INVENTION

The present invention seeks to provide a motor vehicle clutch-release system that is easy to assemble.

The invention thus provides an assembly for putting into place on the fork of a motor vehicle clutch-release system, said assembly comprising:
a shoe forming a sliding surface for an endpiece of a ball pin of the clutch-release system; and
a support including a housing for receiving the endpiece of the ball pin;
wherein the support includes retaining means for enabling the shoe to be fastened to the support.

By means of the invention, it is possible to assemble the shoe with the support at a first production site and to deliver the support with the shoe assembled thereto to a second site where the clutch-release system is assembled in full. This makes it possible to simplify mounting of the clutch-release system.

The shoe may also be assembled on the support in automatic manner, in particular on a machine designed for this purpose.

Preferably, the retaining means provided on the support are arranged in such a manner as to leave clearance between the shoe and the support, enabling the shoe to move relative to the support.

The invention thus makes it possible to ensure that the shoe is centered automatically relative to the clutch-release fork and relative to the ball pin during assembly of the complete clutch-release system.

In an embodiment of the invention, the retaining means comprise one or more bearing surfaces against which at least a portion of the shoe comes to bear, and one or more fastening portions in relief arranged to hold the shoe bearing against the bearing surface(s).

The or each fastening portion in relief may be formed by an elastically deformable tab.

In a variant, the or each fastening portion in relief may be formed by a stud suitable for being flattened, in particular by a riveting die.

In another variant, the fastening portion in relief may be formed by an annular lip suitable for being deformed, in particular by a riveting die.

Preferably, the portion of the shoe bearing against the bearing surface(s) is a peripheral portion of the shoe, which may include an annular peripheral portion that is substantially plane.

In an embodiment of the invention, the support has a cylindrical inside wall, and the bearing surface(s) is/are formed on one or more shapes projecting from the inside wall.

The support can thus be made as a single piece of plastics material, in particular by injection molding.

The shoe may be made of a material selected from: a material containing PTFE and a metal grid, a thermoplastic material, in particular a filled polyamide, a polyimide, polyacetal (POM), polyphenylene sulfide (PPS), or polyetheretherketone (PEEK), this list not being limiting.

The invention also provides a motor vehicle clutch-release system comprising:
a clutch-release fork;
a ball pin including an endpiece; and
an assembly as defined above, fixed on the clutch-release fork.

In an embodiment of the invention, the clutch-release fork includes one or more orifices and the support includes one or more tabs, in particular elastically deformable tabs, suitable for engaging in the orifice(s) of the fork, enabling the support to be fastened on the fork.

The invention also provides a method of manufacturing an assembly for fitting to a motor vehicle clutch-release system, the method comprising the following steps:
providing a shoe forming a sliding surface for an endpiece of a ball pin of the clutch-release system;
providing a support including a housing for receiving the endpiece of the ball pin and arranged to enable the shoe to be fastened to the support; and
fastening the shoe to the support.

The support may include one or more fastening portions in relief that are suitable for being deformed, in particular by a riveting die, for the purpose of holding the shoe on the support.

The fastening portion in relief may be deformed at ambient temperature.

In a variant, prior to deforming the fastening portion in relief, the support may be heated.

In another variant, the fastening portion in relief may be deformed using a preheated tool or a tool on which ultrasound is generated.

### BRIEF DESCRIPTION OF THE DRAWINGS

The invention will be better understood on reading the following detailed description of non-limiting embodiments of the invention, and on examining the accompanying drawings, in which:

FIG. 1 is a diagrammatic and fragmentary perspective view showing the various component parts of a clutch-release system known in the state of the art, and prior to assembly;

FIG. 2 is a diagrammatic and fragmentary view in section on II-II of the FIG. 1 clutch-release system, after assembly;

FIGS. 3 and 4 are diagrammatic and fragmentary perspective views as seen respectively from beneath and from above, showing an assembly in accordance with the invention comprising a support and a shoe;

FIG. 5 is a diagrammatic and fragmentary perspective view of a support in accordance with another embodiment of the invention;

FIG. 6 is a diagrammatic and fragmentary perspective view of the FIG. 5 support with a shoe fixed thereon;

FIG. 7 is a diagrammatic and fragmentary perspective view of a support in accordance with another embodiment of the invention; and

FIG. 8 is a diagrammatic and fragmentary perspective view of the FIG. 7 support with a shoe fixed thereon.

### MORE DETAILED DESCRIPTION

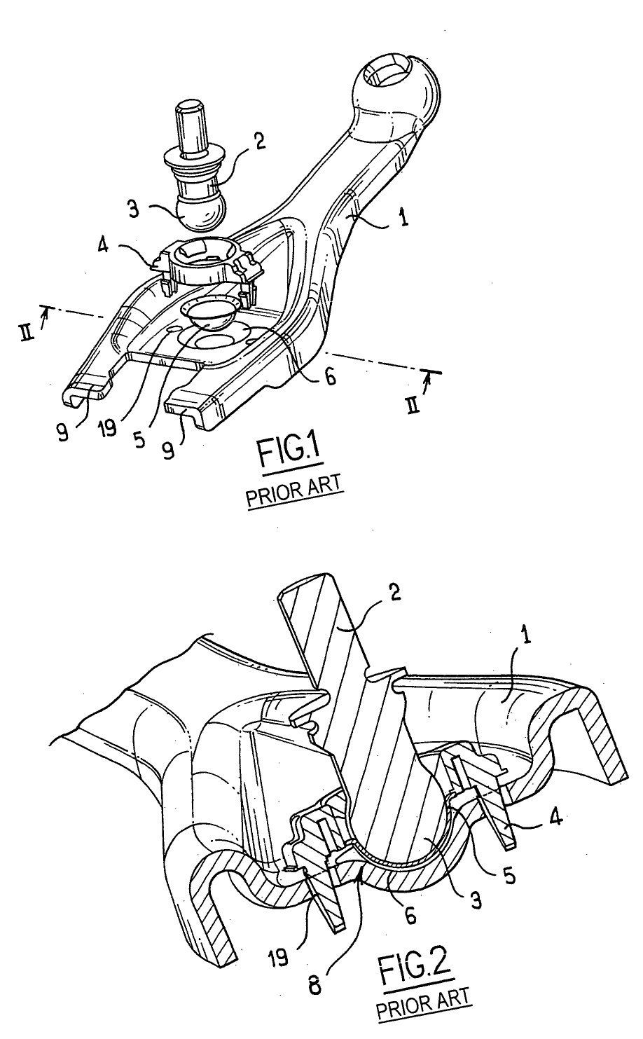

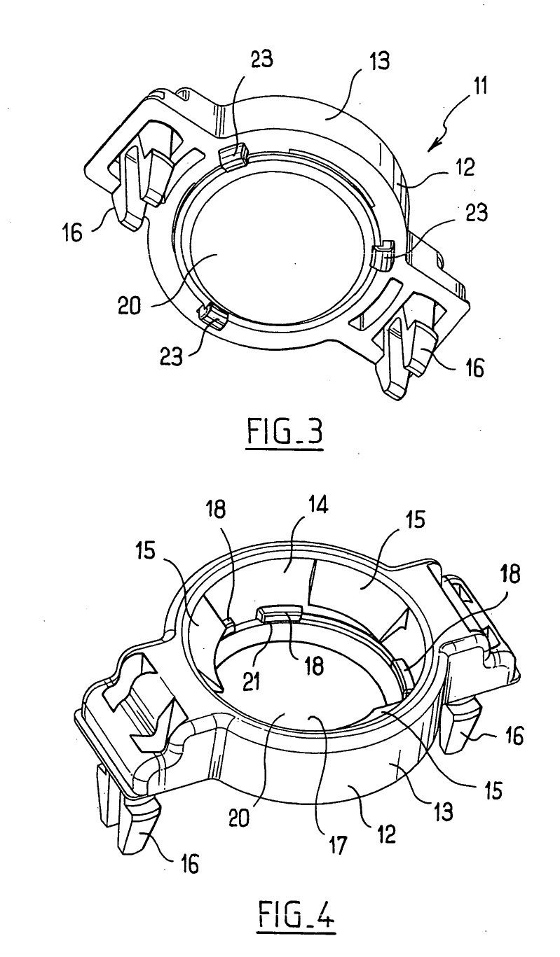

FIG. 3 shows an assembly 11 in accordance with the invention for fitting to a motor vehicle clutch-release system analogous to the system described with reference to FIGS. 1 and 2.

The assembly 11 comprises a support 12 having a ring 13 provided with a cylindrical inside wall 14, as can be seen in FIG. 4.

The support 12 is made by injection molding a plastics material.

The ring 13 defines a housing 17 for the endpiece 3 of the ball pin 2 and is provided with a plurality of tongues 15 forming abutments for retaining the endpiece 3 in the housing 17.

On either side of the ring 13, the support 12 has two fastening tabs 16 suitable for engaging in orifices 19 of the clutch-release fork 1.

The support 12 further comprises teeth 18 projecting from the cylindrical inside wall 14 and forming bearing surfaces against which a substantially plane annular peripheral portion 21 of a shoe 20 comes to bear.

The shoe 20 is generally in the form of a spherical cap and may be made of a flexible material, in particular containing PTFE and a metal grid, or in a variant it may be made of a thermoplastic material having suitable tribological properties, in particular a filled polyamide, POM, PPS, or PEEK.

The shoe 20 is positioned on the bearing surfaces 18 and is held thereon by means of a plurality of fastening portions 23 in relief that are formed integrally with the support 12.

In the example described, each of these fastening portions 23 in relief is formed by an elastically deformable tab, such that the shoe 20 can be put into place on the support 12 by snap-fastening.

In a variant, the shoe 20 may be put into place on the support 12 by initially spreading apart the elastically deformable tabs 23 using a suitable tool, and then placing the shoe 20 on the bearing surfaces 18 before allowing the tabs 23 to return elastically.

As can be seen, the assembly 11 constituted by the support 12 and the shoe 20 can be delivered in the assembled state.

In the example described, the shoe 20 is fastened on the support 12 with clearance allowing the shoe 20 to be centered automatically during assembly of the complete clutch-release system.

The shoe 20 may be fixed on the support 12 in a different way.

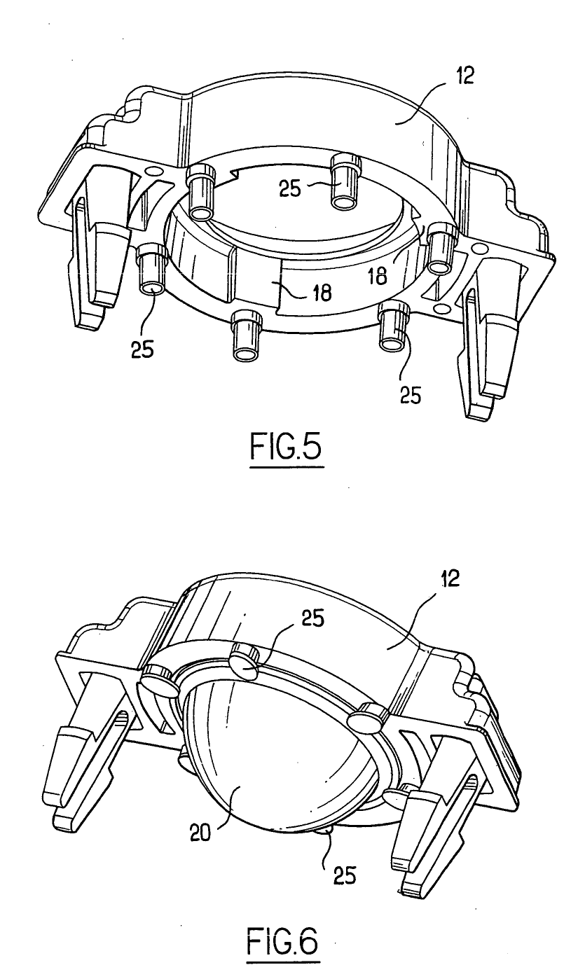

In the example described with reference to FIGS. 5 and 6, the support 12 has a plurality of studs 25 suitable for being flattened, in particular by a riveting die, which studs serve to retain the shoe 20 after it has been put into place on the bearing surfaces 18 and the studs 25 have been deformed.

In the example described, the studs 25 are of a substantially cylindrical state over their entire height.

In a variant, the studs may be of a different shape, for example they may be shaped like the head of a nail, round, or oblong, or they may be constituted by an angled tab.

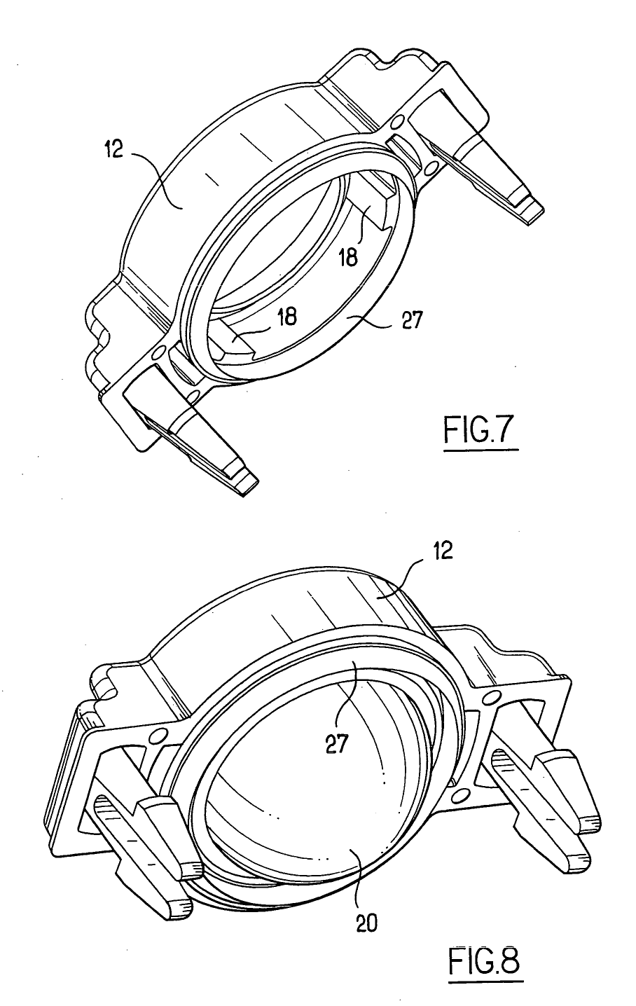

FIGS. 7 and 8 show a support 12 including a fastening portion in relief constituted by an annular lip 27 that is capable of being deformed, in particular by a riveting die, and serving, when in the deformed state, to retain the shoe 20 on the bearing surfaces 18.

In the example described, the annular lip 27 is uninterrupted.

In a variant, it could be interrupted in one or more locations.

The fastening portion(s) in relief may be deformed in various ways.

By way of example, the fastening portion in relief may be deformed at ambient temperature.

In a variant, prior to deforming the fastening portion in relief, the support may be heated.

In a variant, the fastening portion in relief may be deformed using a preheated tool or using a tool on which ultrasound is generated.

Naturally, the invention is not limited to the embodiments described above.

1. An assembly for putting into place on the fork of a motor vehicle clutch-release system, said assembly comprising:
a shoe forming a sliding surface for an endpiece of a ball pin of the clutch-release system; and
a support including a housing for receiving the endpiece of the ball pin;
wherein the support includes retaining means for enabling the shoe to be fastened to the support.

2. An assembly according to claim 1, wherein the retaining means provided on the support are arranged in such a manner as to leave clearance between the shoe and the support, enabling the shoe to move relative to the support.

3. An assembly according to claim 1, wherein the retaining means comprise one or more bearing surfaces against which at least a portion of the shoe comes to bear, and one or more fastening portions in relief arranged to hold the shoe bearing against the bearing surface(s).

4. An assembly according to claim 3, wherein the or each fastening portion in relief is formed by an elastically deformable tab.

5. An assembly according to claim 3, wherein the or each fastening portion in relief is formed by a stud suitable for being flattened, in particular by a riveting die.

6. An assembly according to claim 3, wherein the fastening portion in relief is formed by an annular lip suitable for being deformed, in particular by a riveting die.

7. An assembly according to claim 3, wherein the portion of the shoe bearing against the bearing surface(s) is a peripheral portion of the shoe.

8. An assembly according to claim 1, wherein the shoe includes an annular peripheral portion that is substantially plane.

9. An assembly according to claim 3, the support having a cylindrical inside wall, wherein the bearing surface(s) is/are formed on one or more shapes projecting from the inside wall.

10. An assembly according to claim 1, wherein the support is made as a single piece of thermoplastic material, in particular by injection molding.

11. An assembly according to claim 1, wherein the shoe is made of a material selected from: a material containing PTFE and a metal grid, a thermoplastic material, in particular a filled polyamide, a polyimide, POM, PPS, or PEEK.

12. A motor vehicle clutch-release system comprising:
a clutch-release fork (1);
a ball pin including an endpiece; and
an assembly as defined in claim 1, fixed on the clutch-release fork.

13. A clutch-release system according to claim 12, wherein the clutch-release fork includes one or more orifices and the support includes one or more tabs, in particular elastically deformable tabs, suitable for engaging in the orifice(s) of the fork, enabling the support to be fastened on the fork.

14. A method of manufacturing an assembly for fitting to a motor vehicle clutch-release system, the method comprising the following steps:
providing a shoe forming a sliding surface for an endpiece of a ball pin of the clutch-release system;
providing a support including a housing for receiving the endpiece of the ball pin and arranged to enable the shoe to be fastened to the support; and
fastening the shoe to the support.

15. A method according to claim 14, wherein the support includes one or more fastening portions in relief that are suitable for being deformed, in particular by a riveting die, for the purpose of holding the shoe on the support.

16. A method according to claim 15, wherein the fastening portion in relief is deformed at ambient temperature.

17. A method according to claim 15, wherein prior to deforming the fastening portion in relief, the support is heated.

18. A method according to claim 15, wherein the fastening portion in relief is deformed using a preheated tool.

19. A method according to claim 15, wherein the fastening portion in relief is deformed using a tool on which ultrasound is generated.
